(19) United States
(12) Patent Application Publication
(10) Pub. No.: US 2022/0338632 A1
(43) Pub. Date: Oct. 27, 2022

(54) CONSTRUCTION PANEL WITH MODULAR LATTICE/COMPOSITE DESIGN

(71) Applicant: Charles William Burgett, San Antonio, TX (US)

(72) Inventor: Charles William Burgett, San Antonio, TX (US)

(21) Appl. No.: 17/731,168

(22) Filed: Apr. 27, 2022

Related U.S. Application Data
(60) Provisional application No. 63/180,517, filed on Apr. 27, 2021.

(51) Int. Cl. A47B 96/20

(52) U.S. Cl. CPC A47B 96/205; A47B 2096/207

(57) ABSTRACT

A modular construction panel includes a backing veneer layer, a lattice structure having a plurality of wood strips on a surface of the veneer layer, and a composite material serving as filler material between the wood strips of the lattice structure. The lattice structure includes a plurality of longitudinal wood strips positioned at right angles relative to a plurality of transverse wood strips. The modular construction panel may further include female joiner locks embedded in the filler material. A facing material may be attached to the modular construction panel by coupling to the female joiner locks.

### CROSS-REFERENCE TO RELATED APPLICATIONS

This application claims priority to U.S. Provisional Patent Application No. 63/180,517 filed on Apr. 27, 2021, entitled “Construction Panel With Modular Lattice/Composite Design,” the contents of which are incorporated herein by reference.

### BACKGROUND

### Field of the Art

This disclosure relates to construction panels and, more specifically, in a preferred exemplary embodiment, to a modular panel that is built up as a lattice of hardwood strips on a thin veneer backing sheet, and composite material such as particle board is used as filler material, with female joiner locks that permit attachment of facing material embedded in the particle board portions.

### Discussion of the State of the Art

Construction panels such as those used for many modular furniture kits are typically made of particle board material. Such particle board construction is subject to tearing out of fasteners at mating joints, thereby destroying the integrity of the piece of furniture.

The only conventional technique of overcoming this deficiency of using particle board panels for furniture is that of building the furniture out of more substantive materials such as hardwood or plywood, but such approaches add substantial cost to a furniture design.

### SUMMARY

The present disclosure describes a novel approach for improving construction projects using panels based on particle board composite material by providing a hybrid construction in which a lattice formed of pre-cut wood strips provides strength and modularity and composite material is used as a filler to provide compressive strength and to support female locking pieces that permit facing materials to be added for appearance.

This hybrid approach eliminates the conventional problem of fasteners tearing out of particle board joints since the lattice strips of the lattice structure serve as material to make joints, thereby providing much stronger joints equivalent to those of much more expensive furniture using solid hardwood. That is, when the modular construction board of the present invention is used in lieu of typical construction materials such as plywood, particle board, drywall, MDX, or even cement, the lattice structure provides a strong grid of points with which to connect to other boards or walls without having to use the particulate material, which is a cheaper and less reliable fastening material. The lattice-based panel of the present invention thus effectively provides a panel having the advantage of strength of the lattice material pieces without having to purchase or use an entire panel of this more expensive material.

When used in furniture construction, including, for example, built-in kitchen or bath cabinets, in some exemplary embodiments, this hybrid approach provides panels having exposed portions of the composite material that can have embedded therein female locking pieces, similar to push-in rivets, to permit facing materials to be added for external appearance as a removable facade, as well as functional and decorative knobs and/or handles. When used in a wholesale furniture production environment, these construction panels permit fabrication of particle wood-based furniture that has higher quality and survival rate with minimal cost increase.

The novel construction panels described herein additionally can provide panels that can be used for construction applications other than modular furniture construction, including, for example, floor panels or wall or ceiling panels.

In a preferred exemplary embodiment, the construction panels of the present invention additionally provide composite material that are slightly recessed relative to the external surface of the lattice strips, so that adhesive or mortar material can be easily spread on the exterior surface with no leveling difficulties, in preparation for application of tiles or other covering materials.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a process for making a modular construction panel in accordance with one embodiment of the present invention.

FIG. 2A is a side view of a longitudinal wood strip of the lattice structure in accordance with one embodiment of the present invention.

FIG. 2B is a side view of a transverse wood strip of the lattice structure in accordance with one embodiment of the present invention.

FIG. 2C is a cross-sectional view along line 2C-2C of FIG. 2A in accordance with one embodiment of the present invention.

FIG. 2D is a cross-sectional view of a wood strip in accordance with an alternative embodiment of the present invention.

FIG. 3A is a top view of an exemplary embodiment of the modular panels of the invention having a matrix of female locking nuts incorporated at the center points of the composite material relative to the lattice components.

FIG. 3B is a close up, perspective view of a portion of the panel depicted in FIG. 3A.

FIG. 3C is a cross-sectional view along line 3C-3C in FIG. 3B.

FIG. 4 illustrates how two modular construction panels of size 3′ by 6′ with 6″ lattice intervals, as exemplarily shown FIG. 3A, can be sectioned and joined together to construct a 3′H×3′W×2′D cabinet, when the modular construction panels are designed so there are lattice strips on the vertical and horizontal centerlines, in accordance with one embodiment of the present invention.

FIG. 5A illustrates an alternative form of female locking nuts that would permit the back surface of the veneer backing sheet to be used for attachment points, in accordance with one embodiment of the present invention.

FIG. 5B is a cross-sectional view of a portion of a modular construction panel that includes the double-sided female locking nut illustrated in FIG. 5A.

### DETAILED DESCRIPTION

The present invention discloses a hybrid construction panel using strips of wood that are interlocked to form a lattice structure on top of a veneer panel, with composite material such as particle board used as a filler for the lattice structure. The lattice structure strips can be used to make strong, solid furniture joints where panel sections meet, for example, at corners and edges of cabinets, or for strong attach points for connecting a construction panel to other structural components such as floor or ceiling joists or wall studs. The composite filler material adds overall strength and stability to the panel and can serve as attachment points for facing material or for a surface upon which to apply adhesive or grout for tiles or other facing material.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Overview

The modular construction panels of the present invention are particularly useful for construction projects in a home, office, or shop since they can be used to construct furniture, cabinets, and shelves, but also could be used for coverings for floors, walls, and ceilings.

### Apparatus

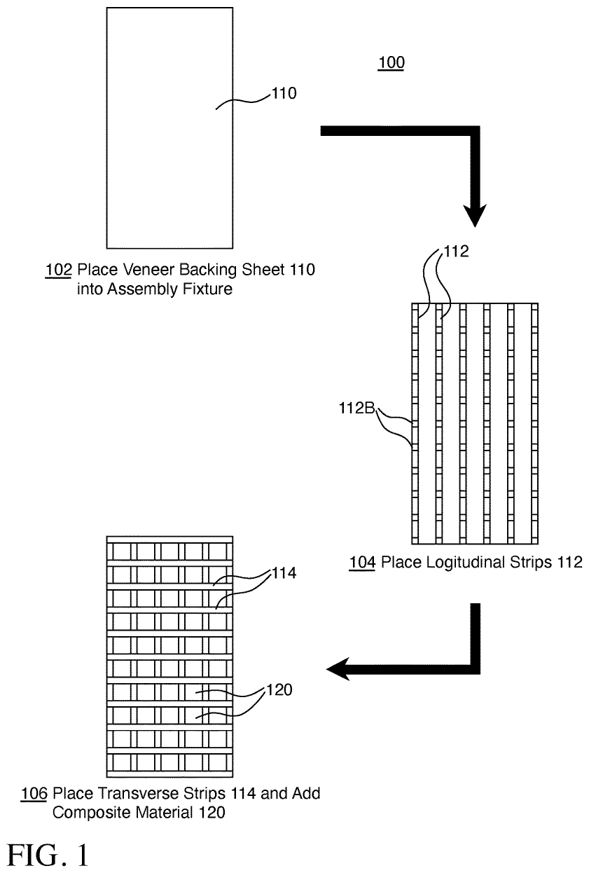

FIG. 1 illustrates the inventive modular panel in accordance with an embodiment of the invention. In particular, FIG. 1 illustrates the basic buildup of components that form the modular construction panels of the present invention by demonstrating a possible exemplary technique 100 of fabricating the modular panels, although it is noted that dimensions provided are exemplary only and not intended as limiting, and the figures used herein to explain the invention are not drawn to scale. Additionally, the fabrication details described may vary depending upon the type of composite material being used as filler material.

In the exemplary embodiments described herein, the composite material is particle board, because one exemplary intended application is furniture and cabinet making, where particle board is already commonly used. Particle board, also known as chipboard, is an engineered product manufactured from wood chips or jute-stick chips and a synthetic resin or other suitable binder, which is pressed and extruded. Often waste-wood such as wood chips, sawmill shavings, or even sawdust are mixed together with resin and treated by a heat pressing process.

Another composite material that could be used in the present invention would be the wood fiber product described as fiberboard, as demonstrated in categories based on density. Standard fiberboard products include low density fiberboard (LDF), medium density fiberboard (MDF) and high density fiberboard (HDF).

In other applications such as floor, wall, or ceiling panels, another possible composite material could be oriented strand board (OSB). OSB is also sometimes used in furniture making. OSB is typically manufactured in wide mats from cross-oriented layers of thin, rectangular wooden strips compressed and bonded together with wax and synthetic resin adhesives. Using OSB as composite might provide a strength/weight benefit compared to using particle board composite.

Yet other applications might use non-wood composite materials, such as ceramic fiber boards made from a wet forming process using alumina-silica fibers and binders. Even paper fibers have been used to form paperboard, which is another composite material that could potentially be used to form panels based on the concepts of the present invention.

FIG. 1 demonstrates how the modular panels could exemplarily be fabricated, although these figures are not drawn to scale. In the first step 102, a veneer sheet 110 of predetermined dimensions, such as a 1/16-inch sheet of size 4′ by 8′ of wood veneer or plastic laminate veneer, is placed in a fixture as might be used to make laminate-coated composite panels such as 4′×8′ laminated particle board panels. In a next step 104, longitudinal lattice strips 112 having length of 8 feet are laid at an interval as predetermined based on an intended application of the finished panel. The length of the veneer sheet 110 and the longitudinal lattice strips 112 is not limited to 8 feet, and other dimensions are within the scope of this invention. The length of the lattice strips 112 is substantially equal to the length of the veneer sheet 110.

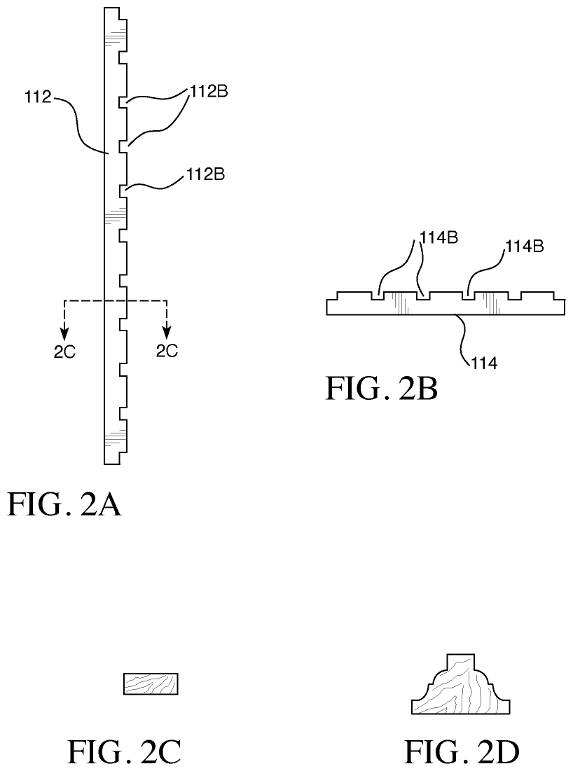

Depending on specific fabrication details, the upper surface of the underlying veneer sheet 110 could be coated with an adhesive to hold the longitudinal lattice strips 112, or the bottom surface of the longitudinal lattice strips 112 could be coated with an adhesive to adhere to the sheet 110. As shown in the side view in FIG. 2A, these longitudinal lattice strips 112 have dado cuts 112B on their upper surface to interlock with transverse lattice strips 114, also having matching dado cuts 114B (see side view in FIG. 2B) on their lower surface that match the interval pattern of the longitudinal strips 112, so that the longitudinal strips 112 and transverse strips 114 will form a lattice, preferably at a 90° angle. In the example of FIG. 1, the interval pattern of the dado cuts 114B in the transverse lattice strips 114 matches the interval pattern of the dado cuts 112B in the longitudinal strips 112, but it should be clear that the two interval patterns (e.g., the longitudinal pattern and the transverse pattern) could differ. The dado cuts 112B and 114B allow for the longitudinal strips 112 and the transverse strips 114 to fit together so that the upper surfaces of the strips 112, 114 lie in the same plane.

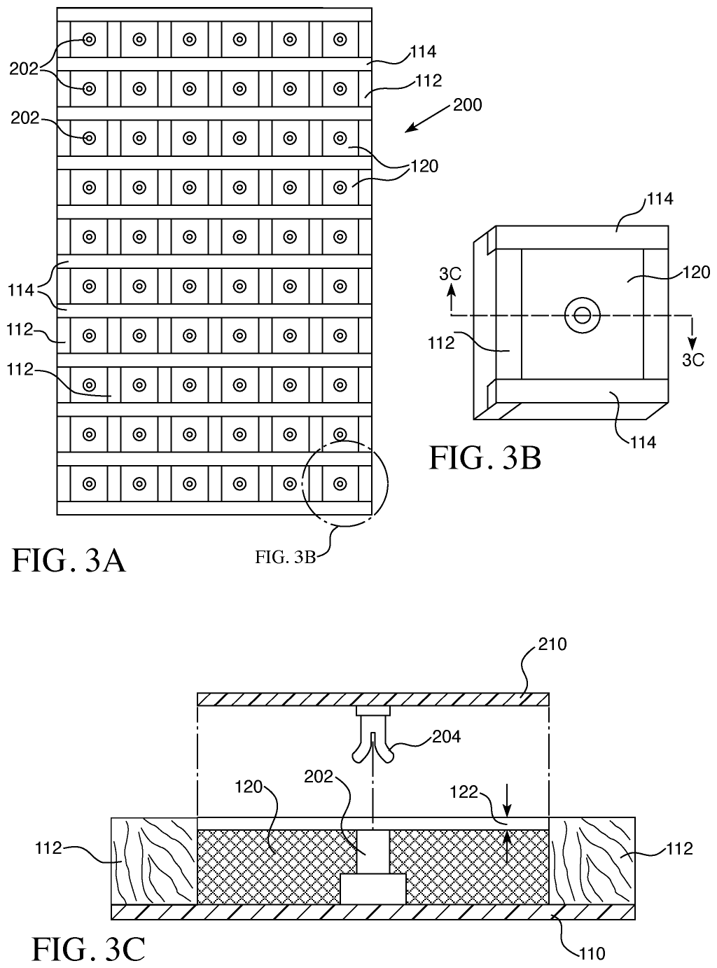

In the next step 106, the transverse lattice strips 114 are placed on the longitudinal strips 112, and, in some exemplary embodiments, female locking nuts (see FIGS. 3A-3C) are placed on the veneer 110 to be embedded by composite material. Composite material 120 is then added as filler in the lattice openings, and the panel is then pressed and heat-treated as necessary to complete curing of the adhesives and composite material 120.

Specific details are not discussed herein of whether adhesives are used for adhering the lattice strips 112, 114 to the backing veneer sheet 110 and the dado cuts 112B of the longitudinal lattice strips 112 to the dado cuts 114B of the transverse lattice strips 114 and, if so, what specific adhesives are used, or whether the resin used to form the composite filler material 120 as this material is added can also serve as an adhesive for the lattice strips 112, 114. These are details that would be straightforward to one of ordinary skill in the art of fabricating composite panels using, for example, particle board composite material. Additionally, the specific details of the exact sequence of how the transverse lattice strips 114 are fitted to the longitudinal strips 112 relative to the addition of the composite material mixture are details considered beyond the scope necessary for understanding the concepts of the present invention and would depend upon different fabrication details of different composite materials, as these various possible composite materials were mentioned above.

Although the lattice strips 112, 114 are depicted as having a rectangular cross-sectional shape, as shown in FIG. 2C, it should be clear that the lattice strips 112, 114 are not limited to this shape. For example, the lattice strips may have rounded corners, grooves, different decorative edging shapes, or the like. In one embodiment, the edges of the strips 112, 114 may be trimmed with different router bits, such as Roman Ogee, double Roman Ogee, wave edge, or the like, so that the strips 112, 114 can be used in a decorative manner. In one example, shown in FIG. 2D, the long sides of the lattice strips 112, 114 have decorative edging. In this manner, the modular panel may be used in coffered ceilings, coffered walls, or the like.

In an exemplary embodiment of modular panels used for construction of furniture and cabinets, as exemplarily shown in FIGS. 3A-3C, the modular panel size is 6′L×3′W, with a 6″ lattice strip interval. The lattice strips 112, 114 are made of, for example, standard dimensional lumber 1″×¾″×6′ and 1″×¾″×3′ strips, with ⅜″ dado cuts, on a 6-inch interval, and particle board, common in furniture making, is used as the composite filler material 120. Hardwood lattice strips are used for this exemplary embodiment because the intended application of these panels is furniture making, where the strength, durability, and workability of hardwood is preferable to a softer wood such as pine or fir.

In other applications, such as construction panels used for flooring, ceiling, or wall panels, a different lattice material such as pine or fir strips and a different composite filler material such as OSB might be preferable, for cost and weight considerations. When the modular panels are intended for use as construction components such as floor or ceiling panels rather than cabinetry panels, the dimensions would preferably match their intended use. For example, floor and roof joists and wall studs are conventionally based on either 16- or 24-inch intervals, so the lattice strips used in modular panels intended for 16-inch construction might be based on such intervals as 4- or 8-inches rather than the 6-inch intervals described for the exemplary embodiment in FIGS. 3A-3C, and 6- or 12-inch intervals might be preferable for lattice strips in construction applications based on 24-inch joist/stud interval construction.

FIGS. 3A-3C also illustrate optional additional features compared to the generic modular panel shown in FIG. 1, when, for example, the modular panels are designed as intended for use in cabinetry, although these features could also be useful in modular panels used in floor, ceiling, or wall applications. First, in FIG. 3A, the dimensions of the generic modular panel is 3′×6′ with 6″ intervals for the lattice strips 112, 114, since cabinetry commonly involves module sizes more reasonably based on 30″ or 36″ than on 16″, 24″, 48″, or 96″, as would be more typical for rough carpentry applications in walls, floors, and ceilings. That is, kitchen floor cabinets are typically 30- or 36-inches high and 24- or 30-inches deep, and kitchen wall cabinets are typically 12-, 18-, or 24-inches deep. In another example, kitchen floor cabinets are 34.5 inches in height with 1.5 inches of countertop attached to the top surface of the cabinets. Thus, for cabinetry applications, a modular panel of size 36-inches by 72-inches with 6-inch lattice intervals would allow these modular panels to be strategically split to become increments of common sizes used for cabinet components. Thus, as shown exemplarily in FIG. 3A (again, not drawn to scale), a 36- by 72-inch (e.g., 3 feet by 6 feet) panel 200 is illustrated using 6-inch intervals for the lattice strips 112, 114. However, it will be well understood by one of ordinary skill in the art that other desired dimensions are possible, depending on the desired dimensions of the cabinet or other component being assembled from the panel 200.

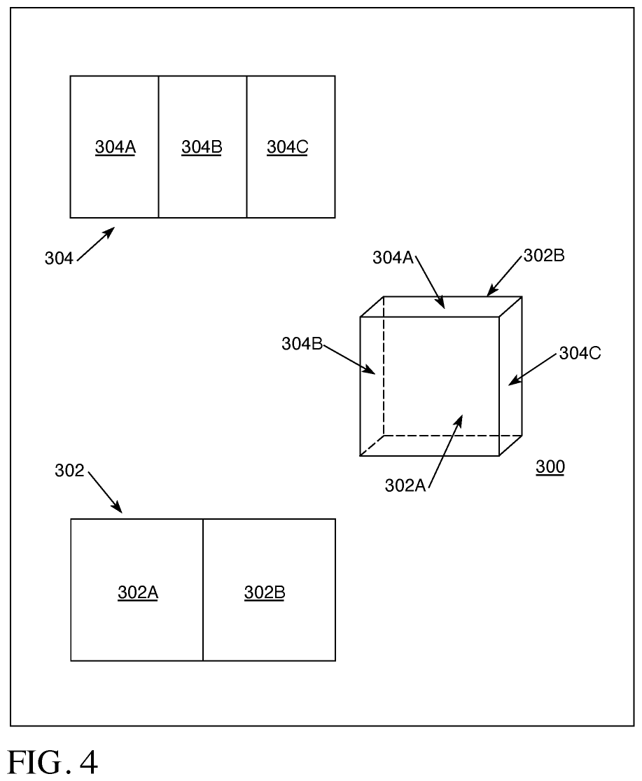

Additionally, it is noted that the panel in FIG. 3A has a lattice member at the centerline of both the vertical and horizontal axes. This feature of centerline lattice members can be important in cabinet construction since, as demonstrated in the example described in FIG. 4, these centerline lattice members permit a panel to be cut exactly in half, with one half of the centerline lattice remaining in each half portion of the divided panel. Since each divided half portion has at least one half of a lattice member on each edge, a stronger joint can be fabricated on each edge since there will be hardwood lattice material available to form an edge joint.

Second, in the exemplary embodiment of FIGS. 3A-3C, nominally at each center of the composite material portion is positioned a female locking joiner insert 202. As shown in cross-sectional view in FIG. 3C, this female locking insert 202 is embedded in the particle board composite material 120, and the particle board composite board material 120 fills the lattice space up to the level of the top of the female locking insert 202, leaving an intentional small gap 122 above this level.

The purpose of the female joiner inserts 202 is to permit facing material 210 to optionally be affixed to the front surface of modular panel 200. For example, if modular panel 200 is used as the front panel in a cabinet carcass of a kitchen cabinet, these female locking joiner inserts 202 would permit sections of facing material 210 to be affixed to the front surface of the cabinet as shown in FIG. 3C, using a male joiner insert 204.

In the exemplary embodiment shown in FIGS. 3A-3C, the female locking joiner inserts 202 are similar to the t-nuts (also called tee-nuts or t-slot nuts) commonly used to fasten a wood, particle board or other composite materials together, leaving a flush surface. The male joiner insert 204 would have an expandable tip, similar to the expandable tip of push-in rivets commonly used in many types of applications including cabinetry, and would be either adhered to the back of the facing material 210, or screwed the back surface of the facing material 210 if it is sufficiently thick. In a preferred exemplary embodiment, the male joiner insert 204 would be sufficiently flexible and shaped to permit the male joiner insert 204 to be withdrawn from the female joiner insert 202, thereby permitting facing material 210 to be removed from the face of a section of modular panel 200 and replaced by other facing material, for example, as furniture styles change over time.

Although a preferred exemplary embodiment places a female joiner insert 202 at the center points of all the composite material portions, it should be clear that in other embodiments the female joiner insert 202 could be located in other locations than the center point of a composite material portion or that the female joiner insert 202 could be placed in fewer than all portions of composite material or even that no female joiner inserts are placed in any composite material portion.

Third, the gap 122 above the composite material 120 is an intentional gap that could serve as a reservoir for adhesive, grout, or other mortar material should the modular panel 200 be used for backing for tiles or a veneer layer that might be used as an exterior appearance finish surface for the modular panel 200.

FIG. 4 illustrates how the modular panels 200 shown in FIGS. 3A-3C would greatly simplify the construction process of, for example, a kitchen cabinet 300 of size 3′height by 3′width by 2′depth, since the modular panel 200 is pre-sized to accommodate modular sizes commonly used in cabinetry. In this exemplary embodiment, the panels shown in FIGS. 3A-3C have been designed so that lattice strips are intentionally located along centerlines. Thus, for example, in FIG. 4, two modular panels 302, 304 will be cut along centerlines of transverse lattice strips to come together to form a cabinet approximately 3′ high by 3′ wide by 2′ deep. One modular panel 302 is split in half to form the 3′×3′ front and rear pieces 302A, 302B of the cabinet carcass, while a second modular panel 304 is trimmed into three 2′×3′ sections, which could form the two sides 304B, 304C and top 304A of the cabinet. By cutting the first modular panel 302 down the centerline of the center transverse hardwood lattice strip, the two side panel portions 304B, 304C can be fastened to corresponding end hardwood lattice strips forming the front and rear pieces 302A, 302B, and the top piece 304A can be fastened using its hardwood lattice strips to the tops of the side, front, and rear cabinet pieces. All cabinet pieces 302A, 302B, 304A, 304B 304C would be fastened by screws or bolts using the hardwood lattice strips on the edges of the sections, thereby providing the strength of hardwood for the joints. Thus, by using the centerline of selected lattice strips as cutting guides, the modular panel permits all cut edges of panels to include at least part of a hardwood lattice strip for use in making a joint. This availability of hardwood material for fabricating joints eliminates the weaker joints in conventional particle board furniture.

If it is desired to apply tiles on the top of the cabinet, by orienting the top section 304A with the composite material side exposed and facing up, the small gap above the composite material could serve to easily apply and level the tile adhesive. By orienting the side sections 304B, 304C to have their veneer backing face outward, this veneer could serve as a final exterior appearance surface for the side panels of the cabinet, and the lattice strips now exposed on the interior side of the side panels 304B, 304C could be drilled with small holes to hang inserts or pegs to support shelves or drawer guides if drawer are to be added inside the cabinet instead of shelves. Similarly, the rear panel 302B could be oriented to use its veneer backing layer as the finished exterior material for the back of the cabinet and use the lattice strips on the interior surface to help support and stabilize shelves if shelves are to be installed.

In contrast to the side and rear panels, the front panel 302A would have its lattice strips facing outward, in order to permit these lattice strips to be trimmed to accommodate two hinged doors for opening up to access an interior having shelves. Alternatively, if drawers are to be added to the interior rather than shelves, then the lattice strips would be trimmed to accommodate openings for slide-in drawers. In either case, whether hinged doors or drawers are chosen, having the lattice strips facing outward on the front panel 302A permits the locking nut inserts in center points of the composite material sections to be used for affixing facing materials for either two hinged doors or for two or more drawer frontispieces, with the door hinge and handle hardware and the drawer knobs being then attached to the front surface of the facing material.

Thus, in view of the simple example shown in FIG. 4, the novel modular panels of the present invention allows any person to do a home kitchen, bathroom, or almost any type of such interior project without having to learn all the skill sets that are conventionally associated with such projects, including easy tiling and construction due to its modular nature.

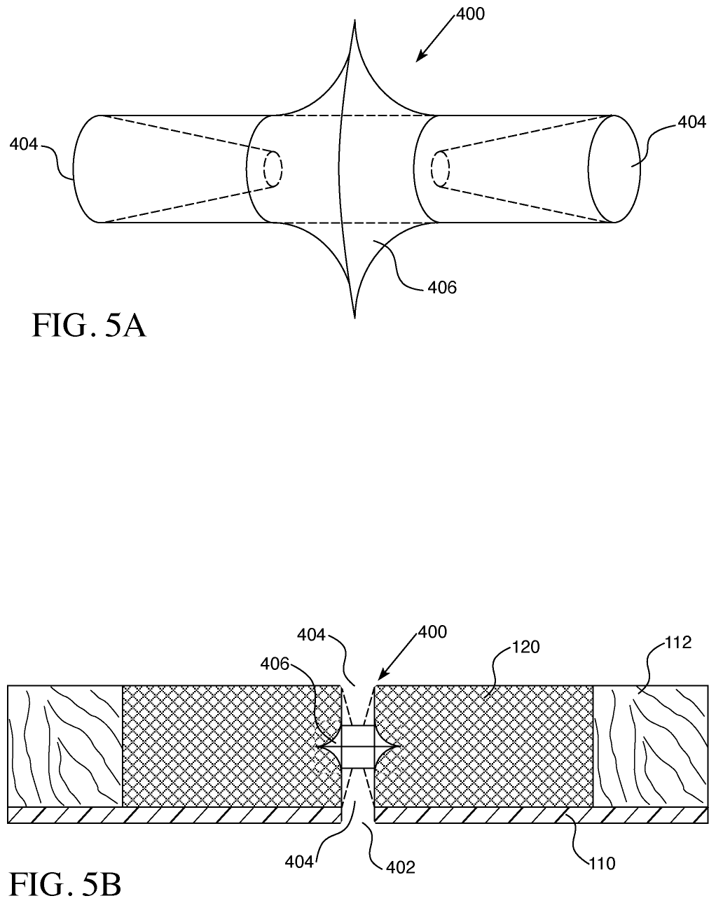

FIGS. 5A and 5B show yet another possible variation in which at least some of the female locking joiners previously described as preferably being in the centers of at least some of the composite material areas are configured as shown in FIG. 5A. This variation of female locking joiners 400 provide a dual-sided female locking joiner element so that the veneer sheet used for backing material, which could include a back surface that has a finish appearance, could also be used to interface with exterior components such as facing materials as described above in the discussion for FIGS. 3A-3C. In this embodiment, since the dual-sided female locking joiner elements are located at known positions in the composite material portions, their locations relative to the finished surface of the back side of the sheet veneer can easily be detected even if not visible, since they could be precisely located by noting the corresponding location on the lattice side of the panel.

The dual sided female locking joiner 400 includes openings 404 on each side and a wedge-shaped central portion 406. The wedge-shaped central portion 406 keeps the female locking joiner 400 in place and prevents it from ripping out of the panel. As shown in FIG. 5B, the female locking joiner 400 is embedded in the composite filler 120 with one of the openings 404 exposed so that facing material may be coupled to the exposed opening 404. The opposite opening 404 is in direct contact with the veneer sheet 110. The veneer sheet 110 may include an opening 402 therethrough that leads to the bottom opening 404 in the female locking joiner 400. Alternatively, the veneer sheet 110 may include a marking or perforated portion that indicates where the bottom opening 404 is. In this manner, facing material may be coupled to the bottom opening 404 through the veneer sheet 110.

This modular type board can be used in lieu of typical construction materials such as plywood, particle board, drywall, MDX, OSB, or sometimes even cement. The lattice structure components of the panels provide a strong grid of attachment points for forming strong joints with other panel sections and to connect to other boards or walls without having to use particulate composite material, which is cheaper and less reliable. The clasping system using the female locking joiner nuts embedded in the composite material creates the ability to further connect any material or prefabricated face such as floor, wall, or ceiling tile, raised wood faces, or any manner of material, with precision and ease and without having to deal with leveling mortar or installing a separate underlayment. Additionally, it is possible to use any material for the veneer backing, as well as permitting more utilitarian use of the back side of the panel by finishing this surface in any desired manner.

The modular panels of the present invention would allow any large scale, mid-level, or small construction project to be completed using a product that has all the advantage of using a whole solid piece of lattice material without having to purchase that much of the product. In cabinetry all of the joints in American or European style cabinets can be connected on a “stud” per se, as meaning one of the hardwood lattice strips, thereby providing a frame for furniture that eliminates the problem of tearing out at connection points in big box furniture conventionally made of particle board composite material. Additionally, a facing material can be connected simply and the connection mechanism even permits such facing material to be optionally disconnected in the future to update for styling. For tiling, the panels create a level surface on which tiles can be connected with room for grout or even flush, and the panels circumvent the need for mortar and leveling.

The modular panels can be fabricated in modular form to allow the user to cut out individual parts to make custom drawers or doors and would allow the user to route the edges of the cut out pieces or the remainder of the board for cabinetry with inset doors and drawers. The female locking inserts also allow for easy installation of knobs or handles for any use.

The modular panels could also be used for high end soundproofing or even modular insulation, and could potentially be used even for roof tiling or solar roof tiling.

### Additional Considerations

As used herein any reference to “one embodiment” or “an embodiment” means that a particular element, feature, structure, or characteristic described in connection with the embodiment is included in at least one embodiment. The appearances of such phrases as “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A modular construction panel, comprising:
a backing veneer layer;
a lattice structure comprising a plurality of wood strips on a surface of the veneer layer; and
a composite material serving as filler material between the wood strips of the lattice structure.

2. The modular construction panel of claim 1, wherein the plurality of wood strips are made of hardwood.

3. The modular construction panel of claim 1, wherein the plurality of wood strips of the lattice structure comprise longitudinal wood strips and transverse wood strips, wherein the transverse wood strips are positioned at a right angle relative to the longitudinal wood strips.

4. The modular construction panel of claim 1, wherein the composite material used as filler material comprises particle board.

5. The modular construction panel of claim 1, further comprising a joiner lock nut embedded in one or more portions of the composite material to provide a female joiner configured for attaching to a facing material.

6. The modular construction panel of claim 1, further comprising a predetermined gap between an upper surface of the composite material and an upper surface of the wood strips of the lattice structure.

7. The modular construction panel of claim 3, wherein the longitudinal wood strips of the lattice structure are attached to the backing veneer layer in a predetermined interval that is based on an intended application for the modular construction panel.

8. The modular construction panel of claim 7, wherein the intended application is cabinetry and the predetermined interval is six inches.

9. The modular construction panel of claim 5, wherein the female joiner is configured for attaching the facing material to a top surface of the modular construction panel, to a bottom surface of the modular construction panel, or to both the top and bottom surfaces of the modular construction panel.

10. A method of construction using a modular construction panel comprising a backing veneer supporting a lattice structure of wood strips and composite material as a filler in the lattice structure, the construction method comprising:
providing a first panel and a second panel by cutting the modular construction panel along a centerline of a selected lattice structure strip so that the first panel comprises a first half of the selected lattice structure strip and the second panel comprises a second half of the selected lattice structure strip; and
attaching the first panel to the second panel at a right angle so that the first half of the selected lattice structure strip is at a right angle relative to the second half of the selected lattice structure strip.

11. The method of claim 10, wherein the modular construction panel further comprises a female joiner embedded in the composite material, and the method further comprises attaching a facing material to one of the first and second panels by attaching the facing material to the female joiner.
